(19) United States
(12) Patent Application Publication
(10) Pub. No.: US 2015/0325022 A1
(43) Pub. Date: Nov. 12, 2015

(54) TECHNIQUE FOR PROCESSING A CHARACTER STRING FOR GRAPHICAL REPRESENTATION ON A MAN/MACHINE INTERFACE

(71) Applicant: ELEKTROBIT AUTOMOTIVE GMBH, Erlangen (DE)

(72) Inventors: Andreas Betz, Stuttgart (DE); Dirk Doerr, Sindelfingen (DE)

(73) Assignee: ELEKTROBIT AUTOMOTIVE GMBH, Erlangen (DE)

(21) Appl. No.: 14/704,471

(22) Filed: May 5, 2015

(30) Foreign Application Priority Data
May 6, 2014 (DE) 10 2014 006 549.9

(51) Int. Cl. G06T 11/60

(52) U.S. Cl. CPC G06T 11/60

(57) ABSTRACT

A computer-implemented method is made available for processing a character string for a graphical representation on a man/machine interface, wherein each character of the character string is represented by a glyph saved in a font library. The glyph assigned to each character provides at least one outline for the character. The method comprises the steps of retrieving at least the outline of each character of the character string from the font library, generating, on the basis of the retrieved outlines, a single path object representing the character string, which comprises at least the outlines of all the characters of the character string, and transferring the path object to a graphics interface for the purpose of graphical representation of the path object. Furthermore, a module for implementing the method is specified.

The present disclosure relates to a technique for processing a character string for graphical representation on a man/machine interface. In concrete terms, a computer-Implemented method is specified for processing a character string for a graphical representation on a man/machine interface.

### BACKGROUND

Vector graphics are playing an ever greater role in the graphical representation of two-dimensional or three-dimensional objects. Vector graphics are based on a mathematical description of the objects to be represented, instead of on a specification of colour values for each pixel of the object to be represented, as is customary in the case of raster graphics. The type of graphical representation of objects (e.g. filling, line thickness, etc.) is defined in vector graphics by means of attributes that are capable of being assigned to the objects. For instance, the object constituted by “circle” can be uniquely described merely by defining a centre of the circle and a radius of the circle. Furthermore, via attribute specifications—such as, for example, contour-line thickness, contour colour, fill colour etc.—it can be defined how the object is to be represented graphically (that is to say, “rendered”).

The advantage of vector graphics over raster graphics lies in the fact that objects to be represented graphically can be described by a data set that is easy to process and that is manageable from the point of view of volume. Processor resources and memory resources are consequently spared. Vector-graphics objects can furthermore be scaled in stepless and lossless manner and are independent of the resolution of a visual output medium. Vector-graphics-based objects can consequently be represented still more rapidly and with higher quality.

Vector graphics are employed for the purpose of realising attractive user interfaces (man/machine interfaces), for the purpose of realising mobile entertainment applications, for navigation applications, or in the field of web browsing, to name just a few examples. But two-dimensional vector graphics also find application for the graphical representation of characters, character strings or texts (also called text rendering). In the case of text rendering, modern applications fall back upon so-called outline fonts. Outline fonts describe an outline (also designated as a contour) of a glyph as an aggregation of complex location vectors, which besides pointing to straight lines and arcs can also point to Bézier curves and splines. By “glyph” in this connection, the concrete appearance of a character is meant. Examples of such outline fonts are the TrueType font, or TTF for short, diverse PostScript fonts, or the OpenType font.

It is to be noted that graphical representations of characters and texts can have great influence on the performance of modern man/machine interfaces. In this connection, quality and speed of character representations depend greatly on the representation process being employed.

### SUMMARY

The object underlying the present disclosure is to specify a method that further improves a graphical representation of characters or character strings on man/machine interfaces.

According to a first aspect of the present invention, a computer-implemented method is made available for processing a character string for a graphical representation on a man/machine interface, wherein each character of the character string is represented by a glyph saved in a font library and wherein the glyph assigned to each character provides at least an outline for the character, the method comprising the following steps: retrieving at least the outline for each character of the character string from the font library; generating, on the basis of the retrieved outlines, a single path object representing the character string, which comprises at least the outlines of all the characters of the character string; and transferring the path object to a graphics interface for the purpose of graphical representation of the path object.

Each character may have been stored as a glyph in the font library. By way of font library, use may be made of FreeType (or also iType). A glyph may represent a concrete appearance of a character. In concrete terms, a glyph may describe how a character is to be graphically represented (rendered).

For the graphical representation, use may be made of vector fonts. In concrete terms, use may be made of outline fonts, in which a glyph is described at least by specification of the outline of the glyph. The outline may describe the contour of a glyph assigned to a character. The outline can be described mathematically by means of vector data. In this case the outline can be described by at least one dosed (and/or open) path. A path may represent a vector-based (closed and/or open) line or shape. Each path may have been defined via a series of points that are capable of being connected to one another via segments. The points may have been defined with respect to a two-dimensional coordinate system (by defining coordinates of points). The segments may represent straight lines, arcs, Bezier curves and/or splines.

The generated path object may comprise all the paths that describe the outline of all the characters of the character string that are to be represented. In other words, the generated path object may comprise all the outlines of the glyphs that are capable of being assigned to the characters of the character string. Consequently, the character string to be represented can be represented by a single path object. A separate path object for the graphical representation is consequently not generated for each glyph of the character string.

Furthermore, the path object may include attribute information that further defines the visual appearance (such as, for example, fill colour, fill pattern, contour line, contour colour, etc.). A path object may consequently comprise all the vector data that are needed for describing a visual appearance of the object to be represented.

Since only a single path object is generated for the character string to be represented, this one path object only can be transferred to the graphics interface for the purpose of graphical representation. The character string to be represented can consequently be transferred as a single object to the graphics interface and processed further. The graphics interface can then process the transferred path object in customary manner, in order to generate, from the vector-based graphics data of the object, image data that are capable of being displayed on a visual output unit.

The step of generating the path object may further include: assembling the retrieved outlines in a sequence of characters that is predetermined by the character string to a single path object. Following the sequence predetermined by the character string, the outlines representing characters can be assembled in such a manner that the horizontal and/or vertical spacing between adjacent outlines takes up an adjustable and/or desired character spacing.

The step of generating the path object may include calculating of a translation (a shift of position) of the outline(s) representing a character relative to a predetermined or calculated position of an outline for a preceding character of the character string. In concrete terms, a translation vector is calculated that specifies how much and in which direction each outline segment (path segment) for a character is shifted with respect to the outline for a preceding character. The positions of the outline (or the position of the paths describing the outline) can be defined with respect to a predetermined relative or absolute coordinate system. The step of generating a path object may consequently include a recalculation of positions of the outlines representing the characters. The generating step may further include a combining of the recalculated outlines to form a single path object. The generated path object may then comprise all the recalculated outlines (path segments) of the character string.

The calculation of the translation or of the translation vector for the outline of each character can be calculated successively on the basis of the respectively preceding character (outline of the preceding character).

The glyphs may further provide at least items of information concerning height, width, offset, kerning and/or coordinate points (e.g. starting-point) for an outline. Via the kerning information a spacing from other characters can be defined, depending on their graphical representation. This information can be utilised, for example, in order to avoid an unusually large spacing between two consecutive characters, or to avoid a ligature. At least one of these items of information can be taken into account in the calculation of the translation of the outline of a character. For example, the width of an outline of a preceding character can be taken into account, in order to calculate a horizontal translation of a following character with respect to the preceding character. Likewise, a height of a character may enter into the calculation of a vertical translation of a character following the character in the vertical direction. Alternatively, height and width may jointly enter into the calculation of a translation, in order to generate a corresponding shift of position in the horizontal and vertical directions of a character with respect to a preceding character.

The translation calculated on the basis of height, width, offset, kerning and coordinate position of the outline of the individual glyphs may be one-dimensional or two-dimensional. One-dimensional translation may mean that the outline of a glyph is shifted with respect to the outline of a preceding glyph in one direction only (either horizontally or vertically). Two-dimensional translation may mean that the outline of a glyph is shifted with respect to the outline of a preceding glyph both in the horizontal direction and in the vertical direction.

The process may further include the step of providing a unified set of attributes for the path object. The set of attributes that is made available can consequently define in unitary manner (that is to say, centrally) the visual representation of all the characters of the character string in detail. As an alternative to this, the path object may also be provided with several sets of attributes, in order to define the visual representation of individual characters of the character string separately.

Additionally or alternatively to this, the process may further include providing items of pattern information or gradient information for the path object. Via the pattern information a fill pattern can be defined with which a character is to be represented. Via the gradient information it can be defined how a defined pattern and/or a filling of the characters is to be changed in the direction of the character string.

The characters of the character string that are to be represented may comprise arbitrary alphabetic characters, numeric characters, syllabic characters, special characters and/or character parts thereof. The character string to be represented may comprise merely one character or several characters. In particular, the character string may comprise a text, assembled from the aforementioned characters, of arbitrary length, a text section, a set or aggregation of several words. According to the present method, an entire text, text section, a set or aggregation of several words can consequently be compiled to form a single path object and can be transferred as such to the graphics interface for drawing.

Furthermore, a computer-program product is provided, with program code for implementing the method described above when the computer-program product is executed on a computer device. In this connection the computer-program product may be stored on a computer-readable recording medium.

According to a further aspect, a module is provided for processing a character string for a graphical representation on a man/machine interface, wherein each character of the character string is represented by a glyph saved in a font library. In this case the glyph assigned to each character provides at least items of Information concerning an outline of the character. The module includes a text-rendering unit configured to retrieve at least the outline of each character of the character string from the font library and to generate, on the basis of the retrieved outlines, a single path object representing the character string, which comprises at least the outlines of all the characters of the character string; and a graphics interface configured to represent the generated path object graphically.

The graphics interface may be designed as a hardware module, as a software module, or as a combined hardware/software module. The graphics interface may include at least one graphics driver and a graphics-processor unit (GPU). The graphics driver may be implemented as a programming interface (API) for processing vector-graphics data (e.g. OpenVG API). The GPU can implement graphics functions for graphical representation of the transferred path object vector data on a visual output unit. Furthermore, the graphics interface may include a graphics memory for storing or buffering path objects.

According to a further aspect, a man/machine interface is provided that includes the module described above. The man/machine interface may be configured to accept instructions and inputs of a user and/or to specify a control surface or control parameters of a machine. The man/machine interface may be part of an infotainment system or navigation system.

### BRIEF DESCRIPTION OF THE DRAWINGS

Further aspects, advantages and particulars of the present disclosure arise out of the following description of the embodiments in connection with the Figures, which show:

FIG. 1 a block diagram of a module for processing a character string for a graphical representation on a man/machine interface;

FIGS. 2a-2c a character string to be represented, and its description as vector data;

FIG. 3 a diagram for illustrating a method for graphical representation of a character string;

FIG. 4 a diagram for illustrating a further method for graphical representation of a character string;

FIG. 5 a diagram for illustrating a method for graphical representation of a character string according to an embodiment;

FIG. 6 a flow diagram for illustrating the method according to the invention; and

FIG. 7 a representation for illustrating a generation of a path object on the basis of the example constituted by the character string shown in FIG. 2a.

### DETAILED DESCRIPTION

The present disclosure will be elucidated with the assistance of schematic block diagrams and flow diagrams. The technical teaching underlying these diagrams can be implemented both in hardware and in software, or in a combination of hardware and software. Such implementations also include digital signal processors (DSP), application-specific integrated circuits (ASIC) and other switching or computing components.

The following description of a method for processing a character string for a graphical representation on a man/machine interface will be described in more detail in connection with the OpenVG standard. OpenVG (open vector graphics) is a vector-based graphics-programming interface (application programming interface, or API for short) developed by the Khronos consortium for hardware-accelerated two-dimensional vector graphics. In the case of OpenVG it is a question of a platform-independent and programming-language-independent software-graphics interface which as abstraction layer is situated between an application program and a graphics-processor unit (in the following, GPU) and assists the linking of application programs to the GPU. In particular, the terminology of OpenVG will be used in the following description. It goes without saying that the method described herein for graphical representation of a character string does not depend on the details of the OpenVG API (in the following, OpenVG driver) but can also be executed in connection with another vector-based (proprietary) API.

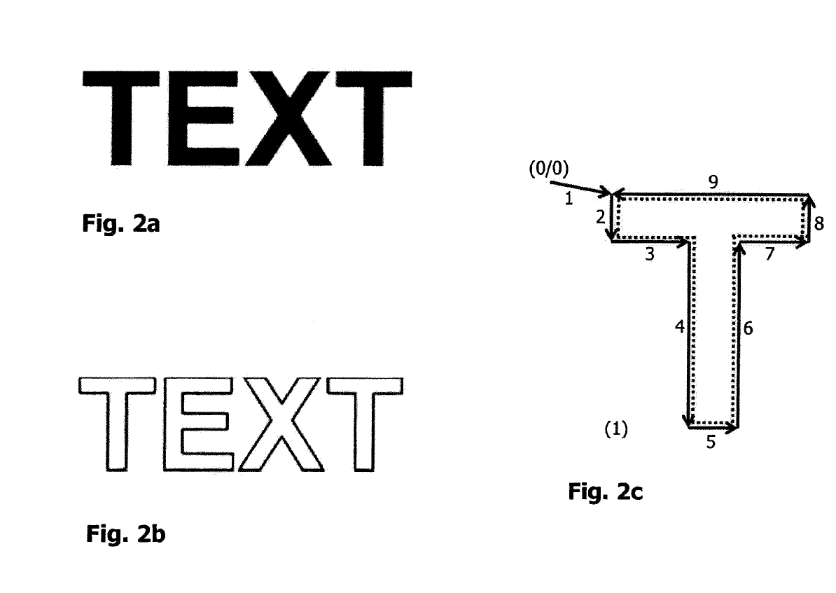

For the graphical representation of the character string, use is made furthermore of a vector font such as, for example, the TrueType font, or TTF for short. In the TTF an arbitrary character is described via an outline of its glyph. The outline represents a contour of the glyph. It is represented by at least one closed (and/or open) plotted line (called “path” In the following) which is described mathematically by vector-graphics instructions. The vectorial description of an outline of a character in connection with the OpenVG standard will be described again in more detail further below with the aid of FIGS. 2a-2c.

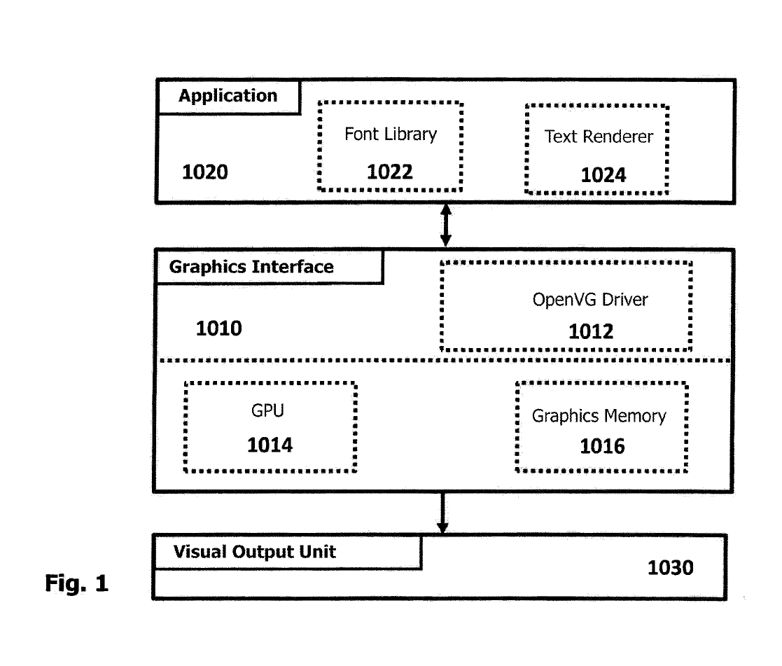

With reference to FIG. 1, firstly an embodiment of a module will be described that is suitable for implementing the method described herein. The module includes a text renderer 1024 and a graphics interface 1010. The graphics interface 1010 includes the OpenVG driver 1012 and the GPU 1014. The graphics interface 1010 may optionally include a graphics memory 1016. The graphics interface 1010 is in communication with a visual output unit 1030 (represented by arrow in FIG. 1). The module may have been implemented in a system such as, for example, an infotainment system, navigation system or smart phone. It goes without saying that in this connection the module described herein may be distributed to various levels of the system. For example, the text renderer 1024 may be embedded at application level, the OpenVG driver 1012 at operating-system level, and the GPU 1014 on a hardware level.

The text renderer 1024 is located together with a font library 1022 at application level. At application level, one or more applications 1020 may be running, such as, for example, a graphical user interface (man/machine interface) which provides a character string to be represented. The character string may in this case comprise an arbitrary aggregation of characters, consisting of one or more characters in the form of alphabetic characters, special characters, numeric characters or syllabic characters. In particular, the term “character string” used herein also encompasses texts, text sections, sentences or an aggregation of words which are to be represented.

In the font library 1022 various vector-based and/or pixel-based fonts may be saved. For the present process, use is made of the TrueType font (TTF). In TTF a glyph of a character is described by its outline (contour) in the form of vector data (path data). Furthermore, items of information concerning the dimensions (height, width), items of offset information (left-side offset, top-side offset), and the kerning of each glyph are provided in TTF. By way of font library 1022, use may be made of FreeType (or also IType), which, inter alila, support the TTF format.

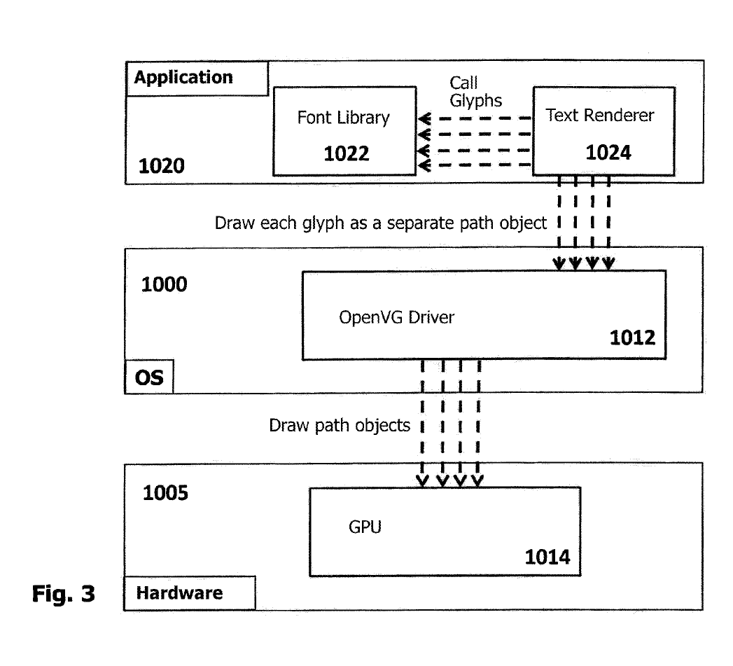

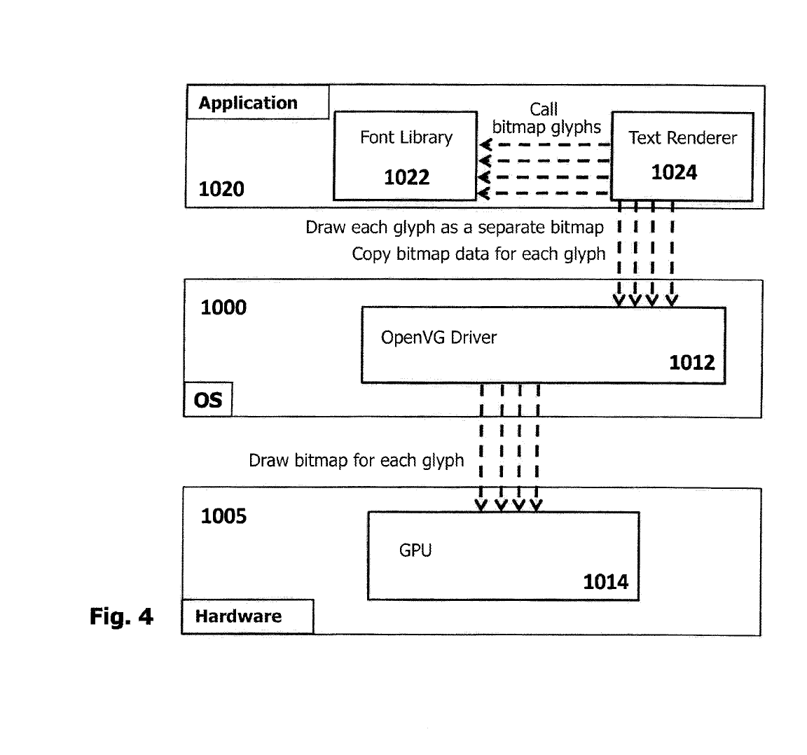

The text renderer 1024 is configured to retrieve the outline of each character (from the font library 1022) and to generate, on the basis of the retrieved outlines, at least one path object. The at least one path object is transferred to the graphics interface 1010 for further processing. The concrete generation of the at least one path object will be elucidated in still more detail in connection with FIGS. 3 to 5. As will furthermore be elucidated in still more detail in connection with FIGS. 3 and 4, in current methods for representing characters a path object is generated for each character of the character string to be represented. In OpenVG each vector graphic is a path object. By “path object”, an object is meant, the visual appearance of which is described by vector data. This means that a path object generated for a character to be represented includes not only the outline-describing paths of the character (in the form of vector data) but also attribute data that define, in concrete terms, how the character is to be visually represented. Attribute data may comprise, for example, a concrete representation of the contour (width, dashed contour, colour), a concrete filling of a surface defined by the (closed) contour, etc.

The graphics interface 1010 is configured to process further the path object on the basis of the paths and attributes provided in accordance with a rendering pipeline implemented in the graphics interface 1010. The rendering pipeline defines in which sequence graphics-processing steps implemented in the GPU 1014 are applied in order to render the path object, i.e. to generate corresponding image data for display on the visual output unit 1030. Conformity and drive of the GPU 1014 are effected in this case via the OpenVG driver 1012, which acts as interface between application 1020 and GPU 1014. In particular, the OpenVG driver 1012 implements a plurality of graphics functions which accelerate the representation of graphical objects.

The image data generated in the GPU 1014 are then output to the visual output unit 1030 for visual representation. The output unit 1030 may be realised as a (touch-sensitive) video screen or projector.

The graphics memory 1016 is configured to store graphics data (path-object data) temporarily that are processed further by the GPU 1014.

With the aid of FIGS. 2a-2c the vectorial description of a character will now be described in more detail within the framework of the OpenVG standard. FIG. 2a shows a character string “TEXT” to be represented, which consists of the four characters “T”, “E”, “X” and “T” and is to be represented with black filling. The filling can be easily defined by an attribute and can be drawn correspondingly by the graphics interface 1010. Consequently, merely the outline of the individual characters has to be retrieved from the font library 1022. The outline of the individual letters “T”, “E”, “X” and “T” is illustrated in FIG. 2b.

With the aid of the text renderer 1024 and the OpenVG driver 1012, for each character of the character string “TEXT” at least one path object is then generated, on the basis of the retrieved outline and on the basis of defined attributes, which describes the visual appearance of the character. OpenVG provides a plurality of attributes in order to define the visual appearance of an object. Attributes of such a type may relate, for example, to the filling of the object (fill colour, fill gradient, fill pattern), the representation of the paths (number of points on the path, type of segment connections, path width, segment-termination style), etc.

FIG. 2c shows, in exemplary manner for the character “T”, how the vector-based description of characters is undertaken under OpenVG. As already mentioned above, the outline of a glyph is described by at least one closed path (plotted line). The path is described by points (two-dimensional coordinate points) and by path segments connecting the points. The path segments are described in OpenVG by corresponding vector-graphics instructions. In concrete terms, the character “T” can be described by the following array of OpenVG instructions:

(1) move_to (10, 10),
(2) line_to (10, 20)
(3) line_to (30, 20)
(4) line_to (30, 80)
(5) line_to (40, 80)
(6) line_to (40, 20)
(7) line_to (60, 20)
(8) line_to (60, 10)
(9) line_to (10, 10).

In this connection the instruction “move_to (x, y)” defines an initial shift of the starting-point (and consequently of the entire outline) with respect to a two-dimensional coordinate system (cf. FIG. 2c, arrow 1), whereby the transferred coordinate values (x, y) define the degree of the shift in both dimensions. The concrete shape of the outline is then defined via the Instruction sequence (2) to (9). The instruction “line_to (10,20)” defines, for example, the path segment of the outline between the coordinate points (10, 10) and (10, 20) as a straight line. In the same way, the following instructions “line_to (x, y)” describe straight line segments of the outline of the character “T” between, in each instance, two following coordinate points. The segments are illustrated in FIG. 2c by corresponding arrows, the above array numbering having been assigned to the arrows. In this connection merely the coordinates of the end-point are transferred to the Instruction “line_to (x, y)”, since in each instance the end-point of a preceding path segment or the starting-point of the outline (“move-to” Instruction) has been defined as starting-point of a path segment. By virtue of the array of instructions described above, a closed path can be generated successively that describes the outline of the character “T”. OpenVG enables, in addition to the representation of straight line segments, also the representation of quadratic or cubic curve segments. These are described by the instructions “quad_to” or “cubic_to”. Overall, it may be noted that in OpenVG a path for describing the outline of an arbitrary character is described by an array of path instructions. The path information defined in the Instruction sequence (1) to (9) can then be used (together with further items of attribute information) in order to describe a graphical representation of the character “T”. The remaining characters “E”, “X” and “T” can be described in the same way.

With the aid of FIGS. 3 to 5, methods for processing a character string with the assistance of the OpenVG driver 1012 will now be described. OpenVG is capable of processing bitmap data and vector data. For the purpose of graphical representation of a character string such as, for example, the character string “TEXT” represented in FIG. 2a, there are two known methods for representing characters, which will be briefly elucidated in FIGS. 3 and 4.

Turning first to FIG. 3, the general functions of the text renderer 1024, of the font library 1022, of the OpenVG driver 1012 and of the GPU 1014 have already been described in connection with FIG. 1. In this context, reference is made to the description of FIG. 1. FIG. 3 differs from FIG. 1 primarily in that the text renderer 1024, the font library 1022, the OpenVG driver 1012 and the GPU 1014 have been represented in a manner corresponding to their apportionment at application level, operating-system level (OS) 1000 and hardware level 1005.

The method illustrated in FIG. 3 is a vector-based method for representing a character string, wherein the outline (that is to say, the path data) of each glyph of the character string to be represented is retrieved from the font library, and a path object for each character is generated for the purpose of graphical representation.

In concrete terms, the text renderer 1024 calls up, for each character of the character string “TEXT”, the outline of the corresponding glyph from the font library 1022. Subsequently, for each character to be represented the text renderer 1024 generates a path object on the basis of the called outline, and transfers said path object to the graphics interface 1010 for the purpose of graphical representation. The generation and transfer of the graphical object are effected by several calls to the OpenVG driver 1012, whereby firstly a call is made in order to generate the path object (vgCreatePath), a further call in order to fill the path object with path data (vgAppendPathData), and a call in order to draw the path object (vgDrawPath). The GPU 1014 then generates, on the basis of the path-object data (these comprise the outline and items of attribute information as already described above in connection with FIGS. 2a-2c), corresponding image data which are then provided to the visual output unit 1030. This procedure is repeated for each character of the character string. In other words, for each character of the character string “TEXT” a separate path object is generated and is transferred to the rendering pipeline of the OpenVG driver 1012. This has been indicated graphically in FIG. 3 by the four arrows between the OpenVG driver 1012 and the text renderer 1024 and between the OpenVG driver 1012 and the GPU 1014, whereby each of the four arrows represents, respectively, a character of the character string “TEXT”. It is to be noted, furthermore, that in FIG. 3 for the sake of simplicity the three calls, cited above, for each character between an application 1020 and the OpenVG driver 1012 have been represented in FIG. 3 only by one arrow.

The method shown in FIG. 4 for representing a character string is a bitmap-based method. It differs from the method shown in FIG. 3 essentially in that the glyphs assigned to the individual characters are represented by bitmaps instead of by outlines. The text renderer 1024 calls up, for each glyph, a corresponding bitmap from the font library 1022. On the basis of the retrieved bitmap glyph, with the aid of the OpenVG driver 1012 the text renderer 1024 then generates an image object and transfers the latter to the graphics interface 1010 for the purpose of graphical representation. The generation and drawing of each image object are effected, once again, by several calls to the OpenVG driver 1012, whereby a first call is made in order to generate an image object, a further call is made in order to fill the Image object with bitmap data, and a further call is made for the purpose of drawing the object. Also with this process, for each character of the character string a separate image object is generated and is transferred to the graphics interface 1010.

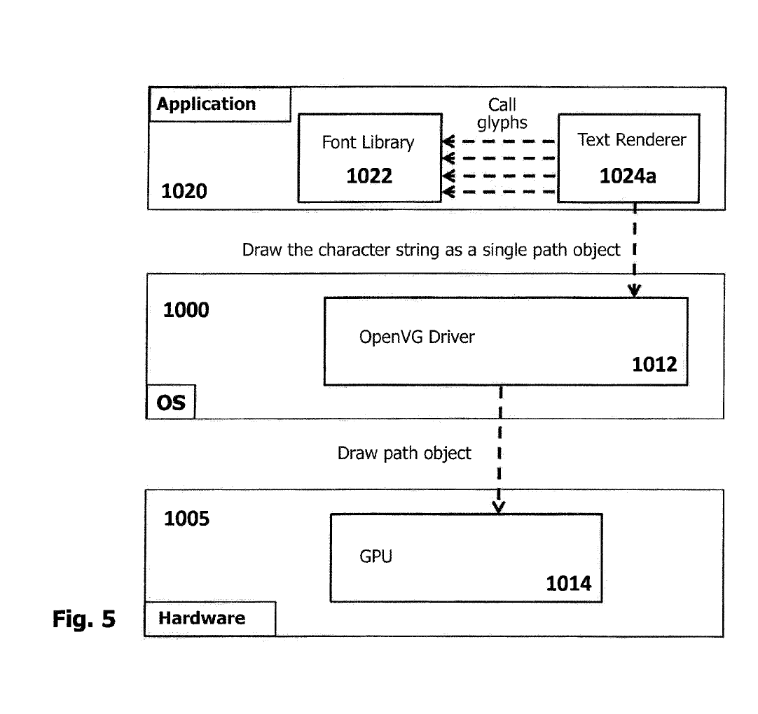

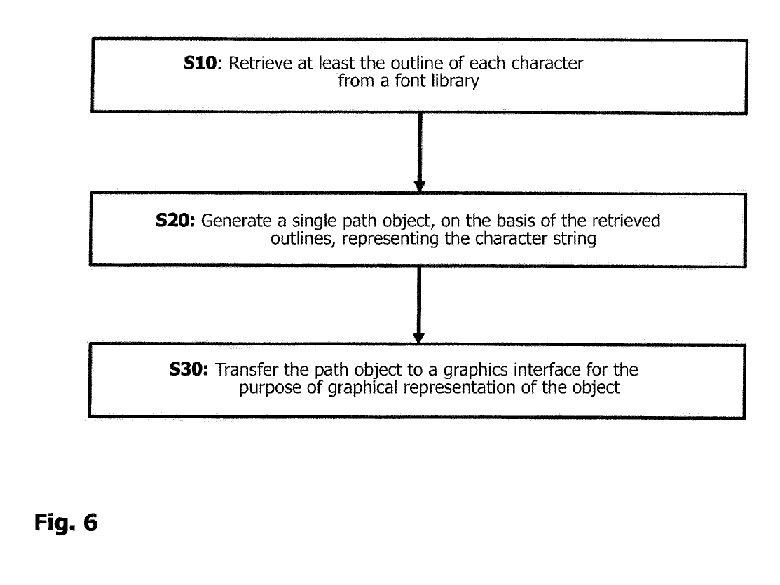

With reference to FIGS. 5 and 6, a method according to the invention for processing a character string for a graphical representation will now be described. FIG. 5 shows once again the interaction of the hardware and software components involved for the representation. As regards the functions of the OpenVG driver 1012, of the GPU 1014 and of the font library 1022, let reference be made once again to the description of FIG. 1. The mode of operation of the text renderer 1024a will be described in connection with the following process. FIG. 6 shows a corresponding flow diagram for the process.

In a first step S10 at least the outline of the glyph for each character of the character string to be represented graphically is retrieved from the font library 1022. The text renderer 1024a has knowledge of the character string to be represented and makes a repeated call to the font library 1022 until all the outlines of the character string have been obtained. Besides the outline, further items of information for the characters can also be retrieved, which have been saved for each glyph in the font library 1022 and may be needed for the graphical representation of the character string. Such items of information relate, for example, to the dimensions, the offset and the kerning of each glyph, as already described above.

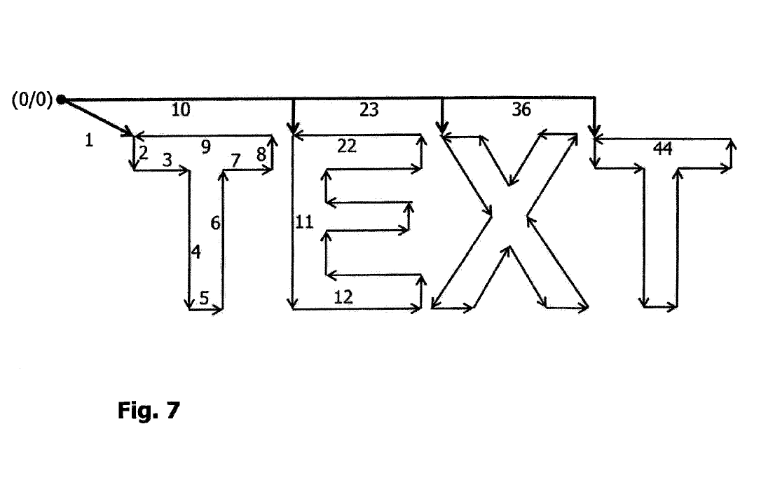

In a second step (S20) a path object for the character string to be represented is then generated. For this, the text renderer 1024a combines all the outlines of the character string that have been obtained into a single path by determining a translation for each outline of a character and recalculating each path segment of the outline with the aid of the translation. The composition (combination) of the outlines into a single path is described in exemplary manner in FIG. 7 on the basis of the character string “TEXT”. What is essential is that, according to the process according to the invention, the text renderer 1024a assembles all the outlines of the character string to form one path and generates a single path object for the entire character string.

The generation of the single path object is then undertaken by a vgCreatePath call, in order to generate an empty path object, and by a vgAppendPathData call, in order to fill the path object with the combined path data.

In a third step S30 the generated path object for the character string is transferred to the graphics interface 1010. The text renderer 1024a transfers the path object to the Interface by a vgDrawPath call. In known manner the GPU 1014 then generates, on the basis of the data obtained, the image information to be represented.

According to the present method, merely one path object is generated for the entire character string to be represented and is transferred to the graphics interface 1010. This is symbolised in FIG. 5 by the one single arrow between the text renderer 1024a and the OpenVG driver 1012 and between the OpenVG driver 1012 and the GPU 1014. In other words, the entire character string is drawn as a single path object. Consequently a separate path object is not generated for each character and transferred to the graphics interface 1010 for the purpose of representation, as is the case, for example, in the methods described in connection with FIGS. 3 and 4. In this way, the number of calls between the OpenVG driver 1012 and the application (or the text renderer 1024) can be drastically reduced. According to the method according to the invention, (n−1) fewer “draw calls” than in the methods discussed with respect to FIGS. 3 and 4 are needed in order to represent a character string with n characters. Each call for generating and drawing path objects takes up resources (memory resources and processor resources) and hence has an effect on the performance of the representation. By virtue of the method described herein, the number of calls is drastically reduced, as a result of which the speed of the graphical character representation is distinctly optimised.

In FIG. 7 the generation of a single path object representing the character string will be elucidated in more detail again on the basis of the character string “TEXT”. The text renderer 1024a is configured to combine all the outlines retrieved from the font library 1022 into a single path. For this purpose, the outlines for the characters are recalculated in accordance with the character sequence and with a desired or predetermined spacing between the respectively consecutive characters. In concrete terms, a one-dimensional or two-dimensional translation for each outline representing a character (that is to say, for each path segment) is calculated which specifies which coordinates the points of the outline take in the path object. The calculation of the outline translation can be undertaken stepwise on the basis of the calculated position information of the preceding outline.

In the example of the horizontally oriented letter string “TEXT”, firstly the outline of the first character “T” is calculated. Since “T” is the first character to be represented, the calculation of the outline or of the path segments does not depend on any other character. The path segments of the first character “T” can therefore be shifted by an arbitrary vector (initial shift with “move-to” instruction). The outline of the first character “T” can be described, for example, by the array of path segments (2) to (9) specified above in connection with FIG. 2c. The outline of the first “T” character is then combined with the outlines of the following characters.

For the combination of the outlines of the two consecutive characters “T” and “E”, the outline of the second character “E” relative to the outline of the first character “T” is shifted by a translation vector (see FIG. 7, arrow 10). Since in the present case it is a question of a horizontal stringing-together of characters, the second character “E” is merely shifted horizontally, the horizontal starting-point of the character “E” being calculated in accordance with the translation rule

“Starting_Point_of_T+Advance_of_T+kerning of_T_to_E+Starting_Point_of_E”.

According to the given translation rule, the starting-point of the character “E” is consequently shifted by the starting-point value of the character “T”, by an advance value of the character “T”, by a kerning value of the character “T” (this value can also be negative) and by a predetermined starting-point value of the character “E”.

In other words, each path segment of the character “E” (that is to say, path segments 11-22 in FIG. 7), and consequently the entire outline of the character “E”, is shifted by a translation defined by the above translation rule. If, for example, the first character “T” takes the values 10, 80 and (−5) for starting-point, advance and kerning in the horizontal direction, and if for the second character “E” the starting-value 0 has been predetermined, then the recalculated starting-value for the outline “E” is shifted in accordance with the equation

start_of_{—}E=(10)+(80)+(−5)+(0)=(85).

All the path segments 11-22 of the outline for the character “E” are shifted by this value.

The shift of an outline of the third character “X”, following the second character “E”, is calculated in the same way, depending on the recalculated coordinates for the outline of the second character “E”, as has been represented by arrow 23 in FIG. 7.

Likewise, proceeding from the recalculated position of the outline for the character “X” the horizontal shift of the fourth character “T” is calculated, as has been indicated by arrow 36 in FIG. 7.

The outlines recalculated with the aid of the above calculation algorithm are then combined into a single path. Correspondingly, for the entire character string a single path object is generated which consists of the following array of instructions.

(1) move_to (10, 10),
(2) line_to (10, 20)
(3) line_to (30, 20)
(4) line_to (30, 80)
(5) line_to (40, 80)
(6) line_to (40, 20)
(7) line_to (60, 20)
(8) line_to (60, 10)
(9) line_to (10, 10)
(10) move_to (85, 10)
(11) line_to (85, 80)
(12) line_to (135, 80)
(13) . . . (21)
(22) line_to (85, 10)
(23) move_to (160,10)
(24) . . . (43)
(44) line_to (235, 10).

The instruction “move_to (85,10)” in array line (10) specifies where the first character “T” ends and the second character “E” begins. Likewise, the instruction “move_to (160,10)” in array line (23) specifies where the second character “E” ends and the third character “X” begins. The instruction “line_to (235,10)” in array line (44) finally specifies where the fourth character “T”, and consequently the character string, ends. Consequently all the paths of the glyphs are assembled in a single object for the purpose of graphical representation.

It goes without saying that the example shown here with a horizontal stringing-together (shift) of a character string has merely illustrative character. Instead of a horizontal translation, the same translation may also be carried out in the vertical direction. Additionally or alternatively to this, it is also conceivable that a corresponding translation is carried out in both directions (that is to say, in the horizontal direction and in the vertical direction). Furthermore, the representation of a character string as a single path object is not restricted to the representation of four characters. Quite on the contrary: since OpenVG specifies no restrictions for the size of the path object, a character string or text of arbitrary length can be modelled as an individual path, and a single path object can be generated for the character string or the text.

The compiling of the characters to be represented into a single path object reduces the number of calls, as presented above. But the compiling described herein to form a path object also affords great advantages in terms of data reduction and avoidance of overhead data. For instance, attribute data, which define particulars of the visual representation of the graphical characters, have to be defined once only for the whole character string. On the other hand, in the case of a glyph-wise drawing, as is the case, for example, in the process shown in FIG. 3, for each glyph the attribute data have to be provided all over again upon generation of a new path object.

1. Computer-implemented method for processing a character string for a graphical representation on a man/machine interface, wherein each character of the character string is represented by a glyph saved in a font library and wherein the glyph assigned to each character provides at least one outline for the character, the method comprising the following steps:
retrieving at least the outline of each character of the character string from the font library;
generating, on the basis of the retrieved outlines, a single path object representing the character string, which includes at least the outlines of all the characters of the character string; and
transferring the path object to a graphics interface for the purpose of graphical representation of the path object.

2. Method according to claim 1, wherein the outline of each character is defined by at least one path, the at least one path being described by vector-graphics instructions.

3. Method according to claim 1, wherein the path object describing the character string is transferred as a unit to the graphics interface for the purpose of graphical representation.

4. Method according to claim 1, wherein the step of generating the path object comprises: assembling the retrieved outlines in a sequence of characters predetermined by the character string to a single path object.

5. Method according to claim 4, wherein the outlines of the characters are assembled in such a manner that a horizontal and/or vertical spacing between adjacent characters takes up a desired character spacing.

6. Method according to claim 1, wherein the step of generating the path object further includes calculating of a translation for the outline of a character on the basis of at least one preceding character of the character string.

7. Method according to claim 6, wherein the translation of the outline of a character is calculated successively on the basis of the respectively preceding character.

8. Method according to claim 6, wherein the glyphs further provide at least items of information concerning height, width, offset, kerning and starting-point of the outlines, at least one of these items of information being taken into account in the calculation of the translation of the outlines.

9. Method according to claim 6, wherein the calculated translation represents a one-dimensional or two-dimensional translation of the outlines.

10. Method according to claim 1, further including:
providing a single set of attributes for the path object, the attributes defining a graphical representation of all the characters of the character string.

11. Method according to claim 1, further including:
providing items of pattern information or gradient information for the path object, which define the graphical representation of the characters in accordance with a predetermined pattern.

12. Method according to claim 1, wherein the representable characters comprise alphabetic characters, numeric characters and/or special characters.

13. Method according to claim 1, wherein the character string comprises words, numbers, an aggregation of words and/or numbers, or a text section.

14. Computer-program product with program code for implementing the method according to claim 1 when the computer-program product is executed on a computer device.

15. Computer-program product according to claim 14, which is stored on a computer-readable recording medium.

16. Module for processing a character string for a graphical representation on a man/machine interface, wherein each character of the character string is represented by a glyph saved in a font library and wherein the glyph assigned to each character provides at least the outline for the character, the module including:
a text-rendering unit configured to retrieve at least the outline of each character of the character string from the font library and to generate, on the basis of the retrieved outlines, a single path object representing the character string, which comprises at least the outlines of all the characters of the character string; and
a graphics interface configured to represent the generated path object graphically.

17. Module according to claim 16, wherein the graphics interface comprises a graphics driver and a graphics processor for the purpose of graphical representation of the path object on a video screen

18. Man/machine interface, including the module of claim 16.
